(19) United States
(12) Patent Application Publication
(10) Pub. No.: US 2008/0010230 A1
(43) Pub. Date: Jan. 10, 2008

(54) HYBRID ASSESSMENT TOOL, AND SYSTEMS AND METHODS OF QUANTIFYING RISK

(76) Inventors: Curtis L. Smith, Idaho Falls, ID (US); S. Ted Wood, Rigby, ID (US); Steven R. Prescott, Rigby, ID (US)

Correspondence Address: BATTELLE ENERGY ALLIANCE, LLC, P.O. BOX 1625, IDAHO FALLS, ID, 83415-3899, US

(21) Appl. No.: 11/428,888

(22) Filed: Jul. 6, 2006

(51) Int. Cl. G06N 5/00

(52) U.S. Cl. 706/45

(57) ABSTRACT

There is disclosed a hybrid assessment tool. In an embodiment, the tool includes code to determine initial cut sets from a model; code to modify the initial cut sets; code to create a logic model representative of a subset of failure combinations created from the initial cut sets; code to convert the logic model representative into a binary decision diagram (BDD); and code to quantify the risk for a scenario. There is disclosed a method of quantifying risk of a scenario. In one embodiment, the method includes determining initial cut sets from a model; modifying the initial cut sets; creating a logic model representative of a subset of failure combinations created from the initial cut sets; converting the logic model into a BDD; and quantifying the risk for the scenario using the BDD. Other embodiments are also disclosed.

### GOVERNMENT RIGHTS

The United States Government has certain rights in this invention pursuant to Contract No. DE-AC07-05ID14517 between the United States Department of Energy and Battelle Energy Alliance, LLC.

### BACKGROUND

Current methods for probabilistic risk and reliability analysis tools use a variety of techniques to determine quantitative probabilities. Traditional tools (such as SAPHIRE software by the Idaho National Laboratory) may use an analysis method with “cut sets” (i.e., the failure combinations) to determine an overall probability of failure for a scenario. Some newer tools utilize an analysis method with binary decision diagrams (BDD) to determine an overall probability of failure for a scenario. However, each of these methods has unique problems.

For a “cut set” analysis, there is typically a first step to determine failure combinations that contribute to the overall probability of failure. Often, this determination results in a range of cut sets from hundreds to millions.

After determining the cut sets, a second step may be performed using currently known tools in which an adjustment is made to the cut sets by the analyst to automatically enhance the realism and accuracy of the results.

Following the second step or “post-processing” step, a third step may be performed in which the cut set results are used to determine the overall probability. However, this final step is usually performed using approximations, as exact calculations may become intractable for cut sets that exceed one hundred. Most cut set-based analysis tools truncate the results to determine only the most likely failure scenarios. Such truncation allows cut set analysis tools to solve any size of problem by evaluating only the top contributors.

For BDD-based analysis, overall probability is typically determined directly from the model since the underlying logic model is converted directly into the BDD. Consequently, BDD-based analysis avoids the use of the approximations discussed above with respect to the third step of a cut set-based analysis. However, since BDD-based analysis uses the model directly, it is not possible to adjust failure scenarios to be more realistic, such as in the second step of the cut set analysis. Further, since the entire model is evaluated using the BDD-based analysis, it is possible to have complex models that are impossible to solve using this technique. This size limitation may limit the general applicability of BDD-based analysis for certain types of large-scale, complex problems.

### SUMMARY OF THE INVENTION

In an embodiment, there is provided a hybrid assessment tool, comprising code to determine initial cut sets from a model; code to modify the initial cut sets so as to create a subset of failure combinations; code to create a logic model representative of the subset of failure combinations created from the initial cut sets; code to convert the logic model representative of the set of results for the failure combinations into a binary decision diagram (BDD); and code to quantify the risk for a scenario using the logic model with a standard mechanism for traversing a tree of the BDD.

In another embodiment, there is provided a system for quantifying risk of a scenario, the system comprising an evaluator to determine initial cut sets from a model; a limiter to modify the initial cut sets so as to create a subset of failure combinations; a sorter to sort the subset of failure combinations using a user-defined level of precision so as to create a further subset of failure combinations within the user-defined level of precision; a generator to create a logic model representative of the further subset of failure combinations within the user-defined level of precision; a converter to convert the logic model representative of the further subset of failure combinations into a binary decision diagram (BDD); and a processor to quantify the risk of the scenario using the BDD.

In yet another embodiment, there is provided a method of quantifying risk of a scenario, the method comprising determining initial cut sets from a model; modifying the initial cut sets so as to create a subset of failure combinations; creating a logic model representative of the subset of failure combinations created from the initial cut sets; converting the logic model representative of the set of results for the failure combinations into a binary decision diagram (BDD); and quantifying the risk for the scenario using the BDD.

In still another embodiment, there is provided a method of quantifying risk of a scenario using a hybrid assessment tool, the method comprising evaluating a model to determine initial cut sets; modifying the initial cut sets to increase realism for a result set of failure combinations; sorting the result set for failure combinations using a user-defined level of precision so as to create a set of sorted results for the failure combinations within the user-level defined level of precision; turning the set of sorted results for the failure combinations within the user-defined level of precision into a logic model representative thereof; converting the logic model representative of the set of sorted results for the failure combinations into a binary decision diagram (BDD); and quantifying the risk for the scenario using the logic model with a standard mechanism for traversing a tree of the BDD.

Other embodiments are also disclosed.

### BRIEF DESCRIPTION OF THE DRAWINGS

Illustrative embodiments of the invention are illustrated in the drawings, in which:

FIG. 1 illustrates an exemplary embodiment of a hybrid assessment tool;

FIG. 2 illustrates an exemplary embodiment of a system for quantifying risk of a scenario;

FIG. 3 is a flow chart diagram illustrating an embodiment of a method of quantifying risk of a scenario; and

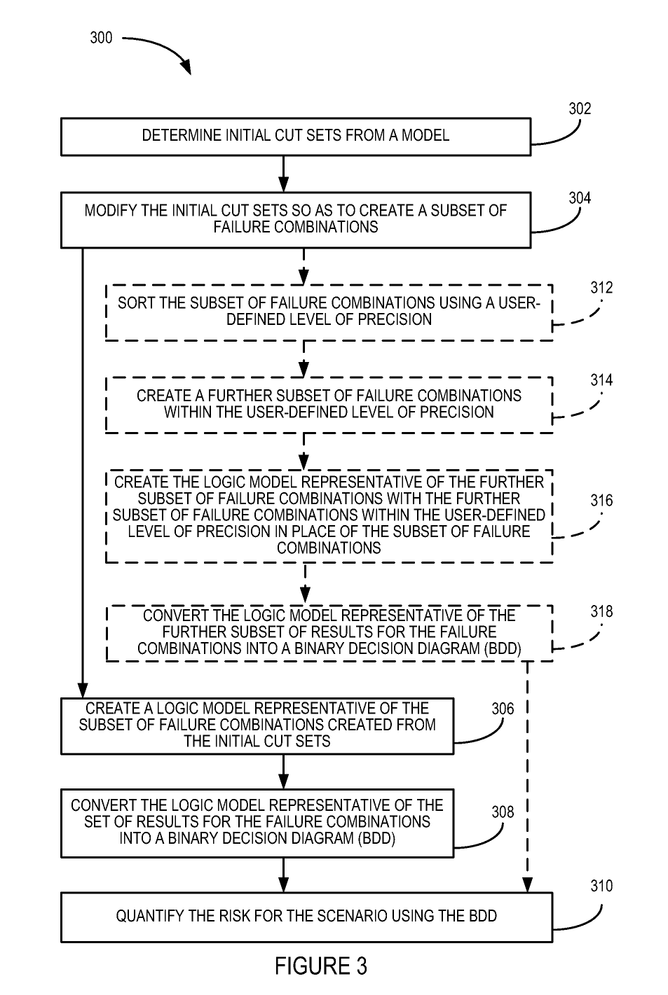

FIG. 4 is a flow chart diagram illustrating another embodiment of a method of quantifying risk of a scenario.

### DETAILED DESCRIPTION OF AN EMBODIMENT

Modern risk and reliability assessment tools quantify logic-based models using a variety of techniques. In an embodiment, there is provided a hybrid assessment tool using both binary decision diagram (BDD) based analysis that qualifies these models, and cut set analysis to adjust these models. Further, this analysis provides results in compact representations of complex models, which facilitates expanded modeling capabilities. This hybrid assessment tool provides precise probabilistic results for logic-based models, which is an improvement over traditional approximation techniques.

To solve quantification problems for risk and reliability analyses, the hybrid assessment tool avoids the key issues from both cut set-based techniques and BDD-based analysis techniques. Specifically, the first step and second step of the cut set analysis is used and the third step is not used. Instead of using the third step of the typical cut set analysis, the resulting cut set from the second step represents a new model, which is passed into a BDD solving routine in order to determine the overall probability.

It may at first appear counterintuitive to begin to start with the cut set analysis and then start again with the BDD analysis. However, by using this hybrid assessment tool, the dominant contributors to the overall probability may be quickly determined using the cut set analysis. These determined cut sets may then be modified to provide increased realism for the analysis. These modified cut set may be very precisely quantified for a complex model.

The goal of many risk or reliability applications is decision making support. At high-risk facilities that rely on these applications, it is critical that realistic models be used and that these models are quantified in a precise manner. The hybrid assessment tool directly addresses both the model realism and quantification precision.

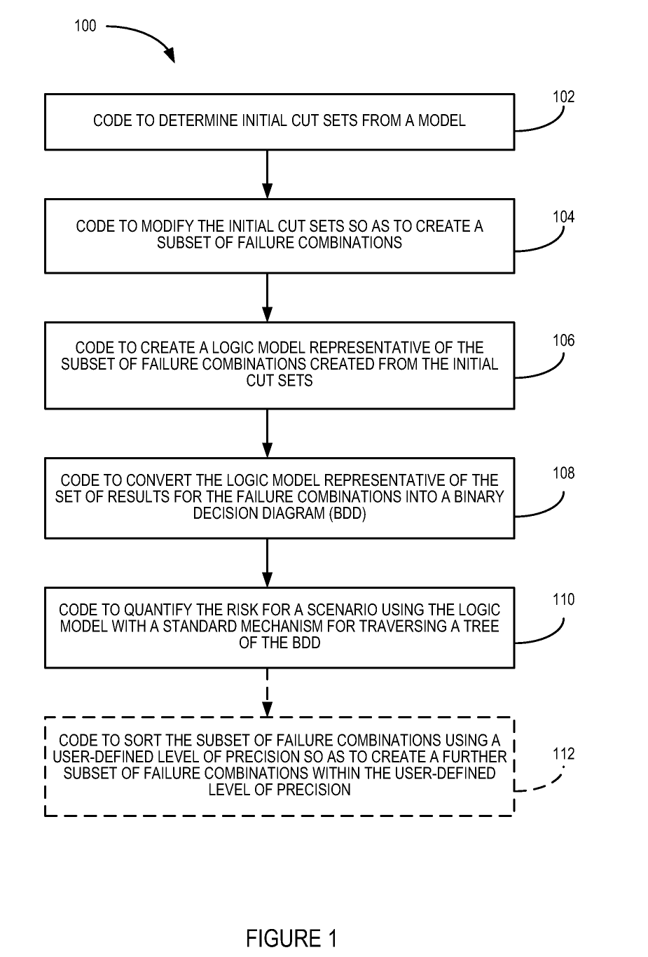

Looking at FIG. 1, and in an embodiment, there is shown a hybrid assessment tool 100. Hybrid assessment tool 100 may include code 102 to determine initial cut sets from a model. Code 104 may be provided to modify the initial cut sets so as to create a subset of failure combinations. Hybrid assessment tool 100 may further include code 106 to create a logic model representative of the subset of failure combinations created from the initial cut sets. Hybrid assessment tool 100 may include code 108 to convert the logic model representative of the set of results for the failure combinations into a binary decision diagram (BDD). Code 110 may be included to quantify the risk for a scenario using the logic model with a standard mechanism for traversing a tree of the BDD.

Generally, code 104 to modify the initial cut sets is adapted to increase realism for the subset of failure combinations with respect to a set of failure combinations within the initial cut sets. Optionally, there is provided code 112 to sort the subset of failure combinations using a user-defined level of precision so as to create a further subset of failure combinations within the user-defined level of precision. In an embodiment, hybrid assessment tool 100 may include code 112 to sort the subset of failure combinations. Code 112 may be included within code 104 to modify the initial cut sets. Furthermore, code 106 may use the further subset of failure combinations within the user-defined level of precision in place of the subset of failure combinations to create the logic model representative of the subset of failure combinations created from the initial cut sets.

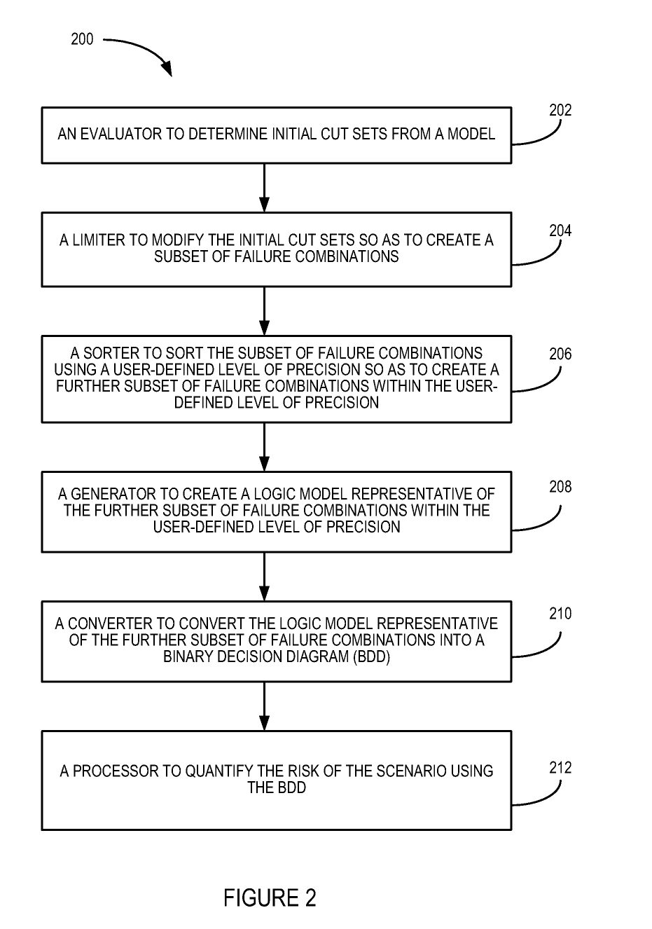

Referring now to FIG. 2, and in an embodiment, there is shown a system 200 for quantifying risk of a scenario using a hybrid assessment tool. An evaluator 202 may be included to determine initial cut sets from a model. A limiter 204 may be provided to modify the initial cut sets so as to create a subset of failure combinations. A sorter 206 may be used to sort the subset of failure combinations using a user-defined level of precision so as to create a further subset of failure combinations within the user-defined level of precision. A generator 208 may be implemented to create a logic model representative of the further subset of failure combinations within the user-defined level of precision. A converter 210 may be used to convert the logic model representative of the further subset of failure combinations into a binary decision diagram (BDD). A processor 212 may be included to quantify the risk of the scenario using the BDD.

In an embodiment, evaluator 202 may use at least one established cut set development technique.

In one embodiment, limiter 204 may be adapted to remove impossible failure combinations from the initial cut sets, add new combinations to the initial cut sets, or adjust existing combinations of the initial cut sets so as to account for unique features in the existing combinations. Limiter 204 may be configured to do more than one of the above described functions. Sorter 206 may be adapted to discard failure combinations outside of the user-defined level of precision.

Optionally, generator 208 may be adapted to develop an internal model for analysis. This internal model is not generally displayed to a user. In an embodiment, the internal model is not stored for use after quantifying the risk for the scenario.

Generally, processor 212 uses standard BDD techniques.

Looking at FIG. 300, and in an embodiment, there is shown a method 300 of quantifying risk of a scenario. Method 300 may include determining 302 initial cut sets from a model. Method 300 may further include modifying 304 the initial cut sets so as to create a subset of failure combinations. Method 300 may include creating 306 a logic model representative of the subset of failure combinations created from the initial cut sets. Next, method 300 may include converting 308 the logic model representative of the set of results for the failure combinations into a binary decision diagram (BDD). Finally, method 300 may include quantifying 310 the risk for the scenario using the BDD.

Optionally, modifying 304 the initial cut sets may include increasing realism of the subset of failure combinations with respect to a set of failure combinations within the initial cut sets. In an embodiment, modifying 304 the initial cut sets may further include sorting 312 the subset of failure combinations using a user-defined level of precision, and creating 314 a further subset of failure combinations within the user-defined level of precision.

In one embodiment, creating 314 the logic model representative of the subset of failure combinations created from the initial cut sets may include creating 316 the logic model representative of the further subset of failure combinations with the further subset of failure combinations within the user-defined level of precision in place of the subset of failure combinations, and converting 318 the logic model representative of the further subset of results for the failure combinations into a binary decision diagram (BDD).

Generally, quantifying 310 the risk for the scenario using the BDD comprises using standard BDD techniques.

FIG. 400 illustrates another embodiment of a method 400 of quantifying risk of a scenario. Method 400 may include evaluating 402 a model to determine initial cut sets. Method 400 may further include modifying 404 the initial cut sets to increase realism for a result set of failure combinations. Next, method 400 may include sorting 406 the result set for failure combinations using a user-defined level of precision so as to create a set of sorted results for the failure combinations within the user-defined level of precision. Method 400 may include turning 408 the set of sorted results for the failure combinations within the user-defined level of precision into a logic model representative thereof. Subsequently, method 400 may include converting 410 the logic model representative of the set of sorted results for the failure combinations into a binary decision diagram (BDD). Finally, method 400 may include quantifying 412 the risk for the scenario using the logic model with a standard mechanism for traversing a tree of the BDD.

Generally, evaluating 402 the model to determine the initial cut sets may include using 414 at least one established cut set development technique.

Optionally, modifying 404 the initial cut sets to increase realism of the result set may include one or more of (a) removing 416 impossible failure combinations from the initial cut sets, (b) adding 418 new combinations to the initial cut sets, and (c) adjusting 420 existing combinations of the initial cut sets so as to account for unique features in the existing combinations.

In an embodiment, sorting 406 the result set for failure combinations using a user-defined level of precision may include discarding 422 failure combinations outside of the user-defined level of precision. In one embodiment, turning 408 the set of sorted results for the failure combinations within the user-defined level of precision into the logic model may include developing 424 an internal model for analysis. Typically, the internal model is not displayed to a user. Furthermore, the internal model is generally not stored.

Quantifying 412 the risk for the scenario using the logic model with the standard mechanism for traversing the tree of the BDD may include determining 426 a probability of the risk for the scenario at the user-defined level of precision.

In one embodiment, a hybrid assessment tool determines an overall probability for risk and reliability models to a user-specified level of precision.

For example, such quantification with the hybrid assessment tool may accomplished as follows. First, the model may be evaluated to determine the most likely or dominant initial cut sets or failure combinations. This may be carried out using established cut set development.

Second, the cut sets may be modified to increase the realism of the results. These modifications may include removing impossible failure combinations, adding new combinations, or adjusting existing combinations to account for unique features in the combination.

Third, the failure combinations may be sorted using the user-defined level of precision so that only those combinations that are outside of the user-defined level of precision are discarded. If the user specifies that the overall probability should be precise to 0.1%, the contribution of 99.9% of the failure combinations are kept for further analysis, and 0.1% of the failure combinations are discarded.

Fourth, the combinations may be turned back into a logic model representative of these results for the failure combinations that are kept. In one embodiment, this model is only developed and analyzed internal to the analysis routine, and this model is not expected to be displayed or stored for other use by the analyst.

Fifth, the logic model is converted into its associated BDD using the newly-developed logic model.

Sixth, the model is quantified using the BDD. Generally, a standard mechanism is used for traversing the tree of the BDD. The result of this quantification is the overall probability of the original risk or reliability model at the user-specific precision level.

Tests were performed to compare systems and methods of quantifying risk of a scenario using a hybrid assessment tool with traditional risk/reliability quantification systems and methods. These tests included a representative model for nuclear power plant risk and a model from NASA. The system and method of quantifying risk of a scenario using the hybrid assessment tool proved to be quite fast and had much better precision than the traditional risk/reliability quantification systems and methods. In one situation, the analysis precision was improved by a factor of 400%.

### Example Implementation

For a risk model for an overall system that contains two subsystems, such as a power supply subsystem and an environmental control subsystem, failure of either subsystem causes failure of the overall system. For the overall system, the Boolean logic structure is:

| | | |
|---|---|---|
| SYSTEM | OR | PS_SYS ENVIR |
| PS_SYS | OR | PS_A PS_B PS_C |
| PS_A | AND | P1 P2 |
| PS_B | AND | P1 P3 |
| PS_C | AND | P2 P3 |
| ENVIR | OR | C1 C2 |

where P1=power supply 1, P2=power supply 2, P3=power supply 3, C1=cooling system 1, and C2=cooling system 2.

Further, assume that the probabilities (Pr) for the components are:

Pr(P1)=Pr(P2)=Pr(P3)=0.1

Pr(C1)=Pr(C2)=0.001

For the overall system, it is critical to model potential recovery if power supply P1 fails in conjunction with power supply 2. The probability that the recovery action (R1) fails is 0.5.

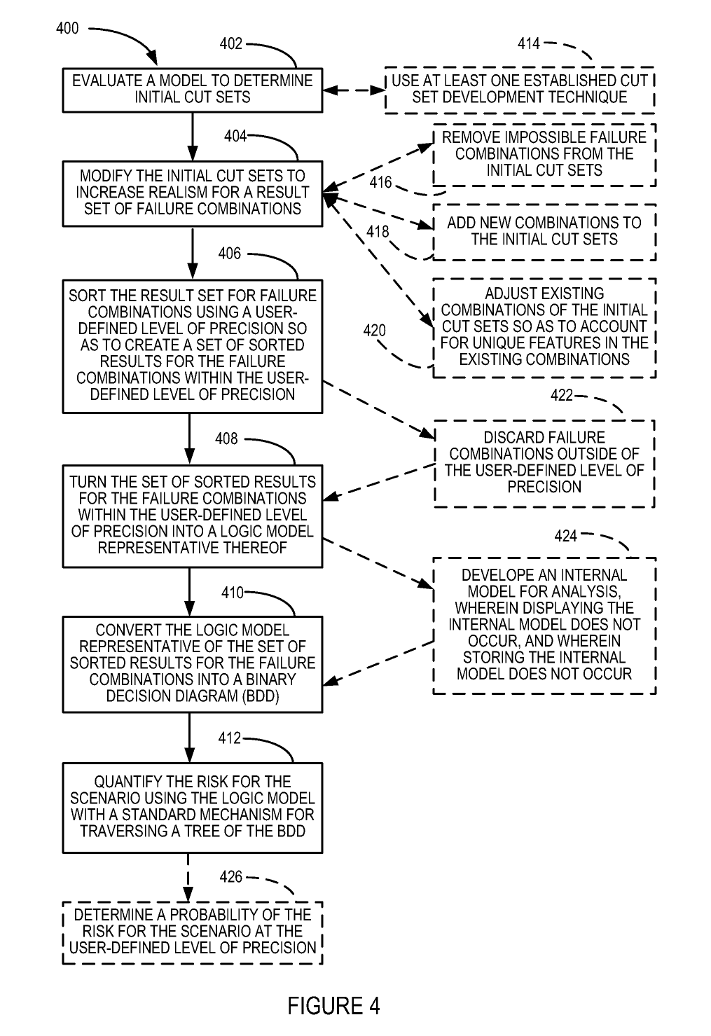

Looking at FIG. 4, method 400 includes the following:

Evaluating 402 a model to determine initial cut sets:

| | | |
|---|---|---|
| Cut set #1 | = | P1 * P2 |
| Cut set #2 | = | P1 * P3 |
| Cut set #3 | = | P2 * P3 |
| Cut set #4 | = | C1 |
| Cut set #5 | = | C2 |

Modifying 404 the initial cut sets for increased realism:

| | | |
|---|---|---|
| Cut set #1 | = | P1 * P2 * R1 |
| Cut set #2 | = | P1 * P3 |
| Cut set #3 | = | P2 * P3 |
| Cut set #4 | = | C1 |
| Cut set #5 | = | C2 |

Sorting 406 the result set using a user defined precision, in which the assumed precision is 1%:

| | | | |
|---|---|---|---|
| Cut set #1 | = | P1 * P2 * R1 | Pr = 0.005 |
| Cut set #2 | = | P1 * P3 | Pr = 0.01 |
| Cut set #3 | = | P2 * P3 | Pr = 0.01 |
| Cut set #4 | = | C1 | Pr = 0.001 |
| Cut set #5 | = | C2 | Pr = 0.001 |

| | |
|---|---|
| Total approximation | Pr = 0.0268 |
| 1% | Pr = 0.0268 * 0.01 = 0.00268 |

Discarding 422 combinations outside precision level:

| | | | | |
|---|---|---|---|---|
| Cut set #1 | = | P1 * P2 * R1 | Pr = 0.005 | Keep |
| Cut set #2 | = | P1 * P3 | Pr = 0.01 | Keep |
| Cut set #3 | = | P2 * P3 | Pr = 0.01 | Keep |
| Cut set #4 | = | C1 | Pr = 0.001 | Discard (less than 0.00268) |
| Cut set #5 | = | C2 | Pr = 0.001 | Discard (less than 0.00268) |

Turning 408 kept failure combinations into a logic model representation:

| | | |
|---|---|---|
| SYSTEM | OR | TERM1 TERM2 TERM 3 |
| TERM1 | AND | P1 P2 R1 |
| TERM2 | AND | P1 P3 |
| TERM3 | AND | P2 P3 |

Converting 410 the logic model representation into BDD:

The BDD is dependent on the order in which the nodes of the tree are constructed. Assuming ordering goes as: P1, P3, P2, and R1, then the BDD is:

| | | |
|---|---|---|
| Node #1 | = | P1, Node #2, Node #5 |
| Node #2 | = | P3, 1, Node #3 |
| Node #3 | = | P2, R1, 0 |
| Node #4 | = | R1, 1, 0 |
| Node #5 | = | P3, P2, 0 |
| Node #6 | = | P2, 1, 0 |

where a node is defined by the event (P1, P2, P3 or R1), its “1 leg” (its output given the node and its “0 leg” (its output given the node does not occur).

Quantifying 412 the risk by traversing the BDD:

Starting with Node #1, each branch of the BDD is evaluated for its contribution to the system re a “1” on the termination point of a let implies a contribution while a “0” implies no contribution:

$$\begin{matrix}SYSTEM = P 1 * P 3 + P 1 * / P 3 * P 2 * R 1 + / P 1 * P 3 * P 2 \\ = 0.0235\end{matrix}$$

where a “/” indicates the complement of the component's failure probability.

What is claimed is:

1. A hybrid assessment tool, comprising:
code to determine initial cut sets from a model;
code to modify the initial cut sets so as to create a subset of failure combinations;
code to create a logic model representative of the subset of failure combinations created from the initial cut sets;
code to convert the logic model representative of the set of results for the failure combinations into a binary decision diagram (BDD); and
code to quantify the risk for a scenario using the logic model with a standard mechanism for traversing a tree of the BDD.

2. A hybrid assessment tool in accordance with claim 1, wherein the code to modify the initial cut sets is adapted to increase realism for the subset of failure combinations with respect to a set of failure combinations within the initial cut sets.

3. A hybrid assessment tool in accordance with claim 1, wherein the code to modify the initial cut sets further comprises code to sort the subset of failure combinations using a user-defined level of precision so as to create a further subset of failure combinations within the user-defined level of precision.

4. A hybrid assessment tool in accordance with claim 3, wherein the code to create the logic model representative of the subset of failure combinations created from the initial cut sets uses the further subset of failure combinations within the user-defined level of precision in place of the subset of failure combinations.

5. A system for quantifying risk of a scenario, the system comprising:
an evaluator to determine initial cut sets from a model;
a limiter to modify the initial cut sets so as to create a subset of failure combinations;
a sorter to sort the subset of failure combinations using a user-defined level of precision so as to create a further subset of failure combinations within the user-defined level of precision;
a generator to create a logic model representative of the further subset of failure combinations within the user-defined level of precision;
a converter to convert the logic model representative of the further subset of failure combinations into a binary decision diagram (BDD); and
a processor to quantify the risk of the scenario using the BDD.

6. A system in accordance with claim 5, wherein the evaluator uses at least one established cut set development technique.

7. A system in accordance with claim 5, wherein the limiter is adapted to at least one of: remove impossible failure combinations from the initial cut sets, add new combinations to the initial cut sets, and adjust existing combinations of the initial cut sets so as to account for unique features in the existing combinations.

8. A system in accordance with claim 5, wherein the sorter is adapted to discard failure combinations outside of the user-defined level of precision.

9. A system in accordance with claim 5, wherein the generator is adapted to develop an internal model for analysis, wherein the internal model is not adapted for display to a user, and wherein the internal model is not adapted for storage for use after quantifying the risk for the scenario.

10. A system in accordance with claim 5, wherein the processor uses standard BDD techniques.

11. A method of quantifying risk of a scenario, the method comprising:
determining initial cut sets from a model;
modifying the initial cut sets so as to create a subset of failure combinations;
creating a logic model representative of the subset of failure combinations created from the initial cut sets;
converting the logic model representative of the set of results for the failure combinations into a binary decision diagram (BDD); and
quantifying the risk for the scenario using the BDD.

12. A method in accordance with claim 11, wherein the modifying the initial cut sets includes increasing realism of the subset of failure combinations with respect to a set of failure combinations within the initial cut sets.

13. A method in accordance with claim 11, wherein the modifying the initial cut sets further comprises sorting the subset of failure combinations using a user-defined level of precision, and creating a further subset of failure combinations within the user-defined level of precision.

14. A method in accordance with claim 13, wherein the creating the logic model representative of the subset of failure combinations created from the initial cut sets includes creating the logic model representative of the further subset of failure combinations with the further subset of failure combinations within the user-defined level of precision in place of the subset of failure combinations, and converting the logic model representative of the further subset of results for the failure combinations into a binary decision diagram (BDD).

15. A method in accordance with claim 11, wherein the quantifying the risk for the scenario using the BDD comprises using standard BDD techniques.

16. A method of quantifying risk of a scenario, the method comprising:
evaluating a model to determine initial cut sets;
modifying the initial cut sets to increase realism for a result set of failure combinations;
sorting the result set for failure combinations using a user-defined level of precision so as to create a set of sorted results for the failure combinations within the user-defined level of precision;
turning the set of sorted results for the failure combinations within the user-defined level of precision into a logic model representative thereof;
converting the logic model representative of the set of sorted results for the failure combinations into a binary decision diagram (BDD); and
quantifying the risk for the scenario using the logic model with a standard mechanism for traversing a tree of the BDD.

17. A method in accordance with claim 16, wherein the evaluating the model to determine the initial cut sets comprises using at least one established cut set development technique.

18. A method in accordance with claim 16, wherein the modifying the initial cut sets to increase realism of the result set includes at least one of chosen from a group consisting of (a) removing impossible failure combinations from the initial cut sets, (b) adding new combinations to the initial cut sets, and (c) adjusting existing combinations of the initial cut sets so as to account for unique features in the existing combinations.

19. A method in accordance with claim 16, wherein sorting the result set for failure combinations using a user-defined level of precision includes discarding failure combinations outside of the user-defined level of precision.

20. A method in accordance with claim 16, wherein turning the set of sorted results for the failure combinations within the user-defined level of precision into the logic model representative thereof includes developing an internal model for analysis, wherein displaying the internal model does not occur, and wherein storing the internal model does not occur.

21. A method in accordance with claim 16, wherein the quantifying the risk for the scenario using the logic model with the standard mechanism for traversing the tree of the BDD includes determining a probability of the risk for the scenario at the user-defined level of precision.
